(19) United States
(12) Patent Application Publication
(10) Pub. No.: US 2004/0184643 A1
(43) Pub. Date: Sep. 23, 2004

(54) Methods and apparatus for imaging

(76) Inventors: Gueorgui H. Stantchev, Phoenix, AZ (US); Lyubomir Cekov, Phoenix, AZ (US); Egidio Cianciosi, Scottsdale, AZ (US)

Correspondence Address: Law Offices of Daniel J. Noblitt, LLC, 3370 North Hayden Road, Suite 123, Box 258, Scottsdale, AZ, 85251, US

(21) Appl. No.: 10/632,303

(22) Filed: Aug. 1, 2003

Related U.S. Application Data
(60) Provisional application No. 60/456,367, filed on Mar. 21, 2003.

(51) Int. Cl. G06K 9/00; A61C 1/00

(52) U.S. Cl. 382/128; 433/25

(57) ABSTRACT

An imaging system according to various aspects of the present invention comprises a sensor providing image data to a data processing unit. The data processing unit suitably comprises an interface that may interact with one or more types of devices, such as a network interface and an adaptable interface. The data processing unit may also include an image processing system for storing image data and/or manipulating the image data to enhance images. The data processing unit may also include a display for viewing images relatively quickly following acquisition of the image data.

### CROSS-REFERENCES TO RELATED APPLICATIONS

This application is a continuation-in-part of U.S. Patent Application No., ______, filed Feb. 14, 2003, entitled DENTAL IMAGING SYSTEM AND APPARATUS USING IEEE 1394 PROTOCOL, and claims the benefit of U.S. Provisional Application No. 60/456,367, filed Mar. 21, 2003.

### FIELD OF THE INVENTION

The invention relates to methods and apparatus for making, storing, transporting, and viewing images.

### BACKGROUND OF THE INVENTION

Teeth and gums are susceptible to a wide array of diseases and disorders that manifest themselves in various ways, including changes in bone and tooth density and geometry. Early detection and diagnosis often allow treatment. Imaging systems, such as radiographical and optical imaging systems, may detect such changes in tooth and bone density and geometry.

Clinical and research examination of oral hard tissues ordinarily employ conventional film-based dental radiography. With this technique, an x-ray source is aligned with a film in the patient's mouth. The film is then developed and inspected for irregularities.

Conventional films, however, need high x-ray dosages, require a relatively long time for processing, and must be replaced after every use. Digital systems, on the other hand, offer high sensitivity and resolution, excellent diagnostic value, and reusability, but have limited flexibility. For example, digital systems ordinarily require a dedicated computer system to interface with other electronic systems, such that image data is transferred to the computer system for processing and transfer to other devices. In addition, digital images are often not available for viewing and manipulation until well after the image is taken.

### SUMMARY OF THE INVENTION

An imaging system according to various aspects of the present invention comprises a sensor providing image data to a data processing unit. The data processing unit suitably comprises an interface that may interact with one or more types of devices, such as a network interface and an adaptable interface. The data processing unit may also include an image processing system for storing image data and/or manipulating the image data to enhance images. The data processing unit may also include a display for viewing images relatively quickly following acquisition of the image data.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps.

FIG. 1 comprises a block diagram of an imaging system according to various aspects of the present invention;

FIG. 2 is a block diagram of a data processing unit;

FIGS. 3A-C are views of a display associated with the imaging system;

FIG. 4 is a flow chart of operation of the imaging system;

FIG. 5 is a flow chart of an auto-balance system;

FIG. 6 is a brightness histogram of an image;

FIG. 7 is a block diagram of a filter system; and

FIG. 8 is a flow chart of a process for reducing sensor non-uniformity and image artifacts.

Elements and steps in the figures are illustrated for simplicity and clarity and have not necessarily been rendered according to any particular arrangement or sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various processing steps. Such functional components may be realized by any number of components configured to perform the specified functions and achieve the various results. For example, the present invention may employ various elements, materials, sensors, processors, communications media, and the like, which may carry out a variety of functions. In addition, the present invention may be practiced in conjunction with any number of applications, environments, imaging techniques, and communications media, and the systems described are merely exemplary applications for the invention. Further, the present invention may employ any number of conventional techniques for manufacturing, assembling, communications, and the like.

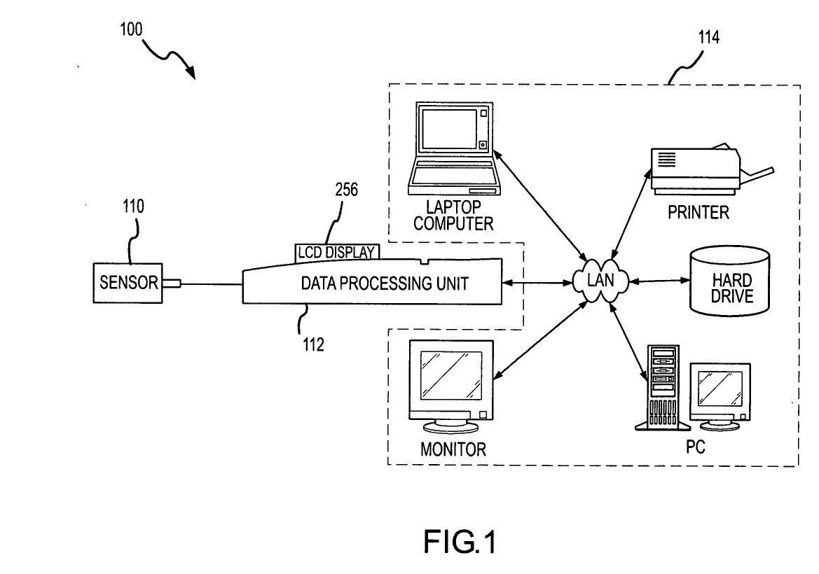

Referring now to FIG. 1, an imaging system 100 according to various aspects of the present invention may be implemented in conjunction with a dental radiography system comprising a sensor 110, a data processing unit 112, and one or more connected devices 114. Generally, the sensor 110 generates data relating to a target, and the data processing unit 112 receives the image data from the sensor 110 and processes the data for use and/or transfer. The connected devices 114 may comprise devices for communicating with the data processing unit 112.

More particularly, the sensor 110 generates data for processing by the data processing unit 112. The sensor 110 may comprise any appropriate sensor for generating information relating to a target, such as a light sensor, magnetic sensor, acoustic sensor, or other sensor. In the present embodiment, the sensor 110 comprises an x-ray sensitive charge coupled device (CCD) for receiving x-ray radiation received via a target, such as one or more teeth, and generating image data corresponding to an image of the target. The sensor 110 may also comprise multiple sensors that may be individually or collectively connected to the data processing unit 112.

The sensor 110 may provide the data to the data processing unit 112 using any appropriate mechanism, such as a wire or cord, a fiber optic cable, a wireless connection, or other suitable medium. The sensor 110 may also comprise any appropriate light sensor, such as a CCD, a complementary metal oxide semiconductor (CMOS) sensor, or other suitable sensor. In the present embodiment, the sensor 110 operates in conjunction with a recognition circuit for identifying the type of sensor connected to the data processing unit 112.

The connected devices 114 comprise devices that may receive information from, provide information to, control, or otherwise interact with the data processing unit 112. In the present embodiment, the connected devices 114 may include master devices configured to control the data processing unit 112, slave devices that receive image data from the master devices and/or the data processing unit 112, and/or combinations of master and slave devices. The connected devices 114 are connected to the data processing unit 112 in any suitable manner, such as via a client-server or peer-to-peer network, for example a local area network, a wide area network, a metropolitan area network, the Internet, wireless connections, telephone connections, or any other suitable system for connecting the data processing unit 112 to the connected devices. In the present embodiment, the connected devices 114 may include storage systems like hard drives or tape drives, printers, monitors, ports to other networks, and other computers. The connected devices 114 are connected to the data processing unit directly or through a network medium, such as a network using one or more communications protocols and/or operating systems, such as Ethernet, Firewire, wireless, UNIX, USB, or other suitable network systems or connections. The imaging system 100 may be configured to support any suitable protocol, operating system, and/or media, for example using hardware, such as plug-in cards or peripheral devices, or software solutions.

The data processing unit 112 receives data from the sensor 110 and processes the data. The data processing unit 112 may be configured in any suitable manner to receive and process the data. For example, the data processing unit 112 may be configured to receive data from multiple types of sensors and process the data to achieve any suitable objective, such as to transfer the data to a device, display the data on a local or remote display, perform image enhancement to improve the quality of the resulting image, store the image data, and/or compress the image data.

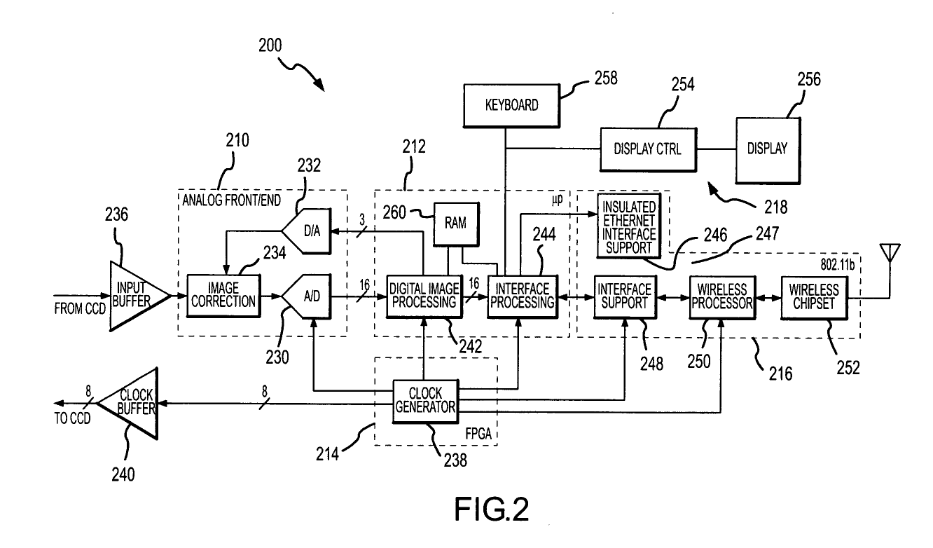

For example, referring now to FIG. 2, a data processing unit 200 according to various aspects of the present invention comprises a conversion component 210, an image processing component 212, a timing and control system 214, an external interface 216, and a display system 218. Generally, the conversion component 210 connects to and/or controls the sensor 110, and converts analog signals to digital signals and vice versa. The image processing component 212 processes the image data from the sensor to extract additional information, improve the data, or otherwise use or store the image data. The timing and control system 214 synchronizes the operations of the various components, and the external interface 216 facilitates interaction between the data processing unit 200 and the connected devices 114. The display system 218 suitably comprises a dedicated display system for displaying image data from the sensor 110. The data processing unit 200 also suitably includes other components, such as a battery power supply and/or power connection.

More particularly, the conversion component 210 comprises a system for converting signals from the sensor 110 into a form for use by the remainder of the data processing unit 200. For example, the conversion component 210 of the present embodiment includes an analog-to-digital converter (ADC) 230 for converting analog signals from the CCD of the sensor 110 to digital form, such as a 16-bit digital signal.

The conversion component 210 may also perform preliminary processing to condition the data. For example, the conversion component 210 may include an image correction module 234 configured to receive analog signals from the sensor 112 via an input buffer 236 and adjust the gain and offset of the incoming analog signal, such as to match the input scale of the ADC 230. The parameters for such adjustments may be static, such as retrieved from a memory, or may be dynamically calculated, for example by the image processing component 212 or the image correction module 234. The conversion component 210 may include a digital-to-analog converter (DAC) 232 for converting digital data from other components into analog form for use by the conversion component 210 and/or the sensor 112, such as image correction information generated by or stored in the digital portions of the data processing unit 112 or the connected devices 114.

The timing and control system 214 provides timing and control signals for coordinating the operation of various elements of the data processing unit 200. The timing and control system 214 may also provide timing and control signals to other elements of the imaging system, such as the sensor 110. The timing and control system 214 may comprise any suitable timing and control system for generating suitable timing and control signals, such as a convention clock signal generator 238. In the present embodiment, the timing and control circuit 214 provides timing and control signals to the sensor 112 via a sensor buffer 240. The timing and control circuit 214 also provides timing and control signals to various other components of the data processing unit 200 to synchronize operations.

The image processing component 212 processes the digitized image data to store the data, transfer the data, and/or provide additional processing to enhance the image data from the sensor 112. The image processing component 212 may be implemented in any appropriate manner and may perform any suitable processing of the image data. For example, the image processing component 212 suitably comprises a single microprocessor, digital signal processor, or controller for performing image processing. In the present embodiment, the image processing component 212 implements an image enhancement module 242 to process the image data. The present image processing component 212 may also include an interface processing module 244 configured to transfer image data to the display system 218 for display. The image processing component 212 may also include a memory, such as a local random access memory 260 (RAM), a read-only memory, a flash memory, or other suitable storage system. The size and type of the memory may be selected according to any suitable criteria, such as the amount and type of data to be stored.

The image enhancement module 242 may be configured to process the image data according to any suitable process to enhance the image. The image enhancement module 242 may perform any appropriate image processing, such as brightness adjustment, contrast adjustment, data smoothing, artifact removal, noise removal, or other suitable processing. For example, in the present embodiment, the image enhancement module 242 is configured to automatically adjust the gain of the image data to generate an enhanced image. The image enhancement module 242 of the present embodiment is also suitably configured to remove artifacts, distortions, and/or noise from the image data.

The image enhancement module 242 may implement any suitable algorithm for adjusting the light balance and/or removing noise. For example, to adjust the light balance of the image data, the image enhancement module 242 of the present embodiment identifies selected characteristics of the image data, such as the brightest pixels, the darkest pixels, and the average brightness among the pixels. The image enhancement module 242 then suitably adjusts the brightness of the image data automatically to either brighten or darken the image.

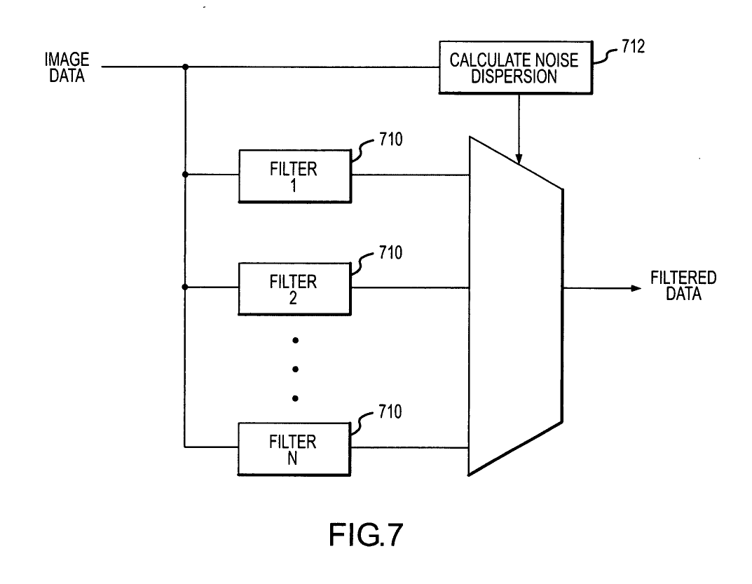

Similarly, the image enhancement module 242 may use any appropriate system for removing noise from the image. For example, in the present embodiment, the image enhancement module 242 includes multiple filters 710 having different qualities (FIG. 7). The image enhancement module 242 may analyze the image data for noise to determine which filter to use to reduce noise but maintain the image quality. In one embodiment, the image enhancement module 242 analyzes the image data from an isolated portion of the sensor 112 for noise dispersion 712. If the noise dispersion is high, then the image enhancement module 242 may filter the image data using a stronger filter for greater noise reduction, but which may tend to decrease image sharpness. Conversely, if the noise dispersion is low, the image enhancement module 242 filters the image data via a weaker filter, which tends to preserve image sharpness.

The interface processing module 244 may be configured to process the image data for use by other systems, such as for transfer to the connected devices 114. The interface processing module 244 suitably receives data after processing from the image enhancement module 242 and conforms the data for output to a relevant device. The interface processing module 244 suitably facilitates interaction with other devices such that the data processing unit 112 may operate as a network device and interact with various types of devices using different protocols, formats, and operating systems.

For example, data received by the interface processing module 244 from the data processing unit 112 may comprise data in a raw format. For storage in a hospital computer system, the interface processing module 244 suitably converts the raw data into a DICOM format. If the device to use the image data is a computer, the interface processing module 244 may change the image data into a computer format, such as a bitmap, JPEG, GIF, or a suitable Internet protocol. The interface processing module 244 may also format the data for transfer and/or storage according to the destination device or system. For example, in an Ethernet system, the interface processing module 244 suitably generates the packets for transfer of the data. The interface processing module 244 also receives information from other devices and formats the received data for use in the data processing unit 112. The interface processing module 244 can send the same image immediately or later, in the same or various formats, to more than one slave device.

Processed image data from the image processing component 212 may be provided to other components, for example for display, printing, processing, and/or storage. The external interface 216 facilitates transfer of information and commands between the data processing unit 200 and the connected devices 114. The external interface 216 may be configured to receive image data from the image processing component 212 and facilitate transfer to the appropriate connected devices, as well as receive information from connected devices for use by the data processing unit 112.

The external interface 216 may comprise any appropriate connectors and associated systems, such as network, telephone, coaxial, USB, FireWire, PCI, Ethernet, Internet, DICOM, or other hardware and connectors. For example, in the present embodiment, the external interface 216 includes an Ethernet interface 246 for connecting the data processing unit 200 to a network. The external interface 216 also suitably includes an adaptable interface 247, such as a PC card slot for receiving PC cards, such as FireWire, USB, wireless networking, or other cards.

In the present embodiment, the PC card slot may contain a wireless networking card, such as a conventional wireless networking card including an interface support module 248, a wireless processor 250, and a wireless chipset 252. The interface support module 248 facilitates transfer of data between the wireless processor 250 and the image processing component 212. The wireless processor 250 operates the wireless chipset 252 and the interface support module to facilitate the transfer of information between the image processing component 212 and a wireless network node. The wireless chipset 252 handles the data transferred between the wireless processor 250 and the wireless network.

Any appropriate interface may be used for the external interface 216 according to the desired and/or anticipated connected devices. For example, the external interface may include a FireWire connection or FireWire card in the PC card slot to facilitate connection to a FireWire computer. Consequently, the data processing unit may be configured to operate with desired systems.

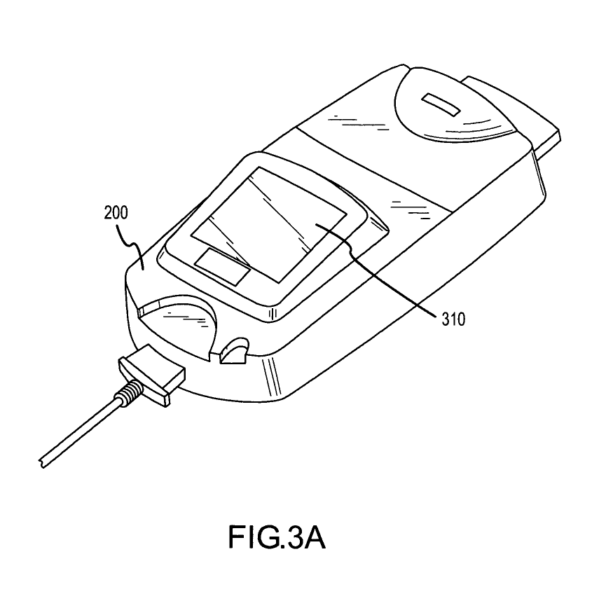

The image processing component 212 may store image data in the local RAM 260 until the image data is ready for transfer to a connected device 114, or directly transfer the data to the connected device 114. Data from the image processing component 212 may also be provided to local components in the data processing unit 200. For example, the data processing unit 200 may be equipped with the display system 218 for displaying data locally, for example prior to transfer to a connected device to ensure acceptability of the image. Referring to FIGS. 2 and 3A, one embodiment of a data processing unit 200 according to various aspects of the present invention includes a dedicated display system 310, for example integrated into the data processing unit 200, such that the display displays images provided by the data processing unit 200. Alternatively, referring to FIGS. 3B-C, the display system 218 may include a remote viewer 312 that may be connected to the data processing unit 200, for example via a wire or wireless connection. The remote viewer 312 may also be configured to mate with the data processing unit 200 for example to recharge batteries in the remote viewer 312.

Referring again to FIG. 2, the display system 218 includes a display controller 254 and a display 256. The display controller 254 receives image data from the image processing component 212 for display on the display 256. The display controller 254 transfers the image to the display to render an image.

The display 256 receives the image data and generates a corresponding image for the user to view. The display 256 may comprise any suitable display for rendering an image according to the image data, such as a cathode-ray tube, a liquid crystal display (LCD), a plasma display, or other mechanism for visually providing information to the user. In the present embodiment, the display 256 comprises a relatively small but high-resolution display, such as a two- or three-inch diagonal LCD, to reduce the weight and awkwardness of the data processing unit 200.

The data processing unit 200 may also include an input interface for providing commands to the imaging system. The input interface may comprise any suitable interface for providing signals from the user to the imaging system 100, such as one or more buttons, a keyboard, a touch screen, or other suitable mechanism. In the present embodiment, the data processing unit 200 includes a dedicated keyboard 258 integrated into the data processing unit 200. The keyboard facilitates use of the imaging system 100, for example transmitting signals to take images, review images stored in memory, adjust the parameters or preferences of the imaging system 100, transfer information to the connected devices, and the like.

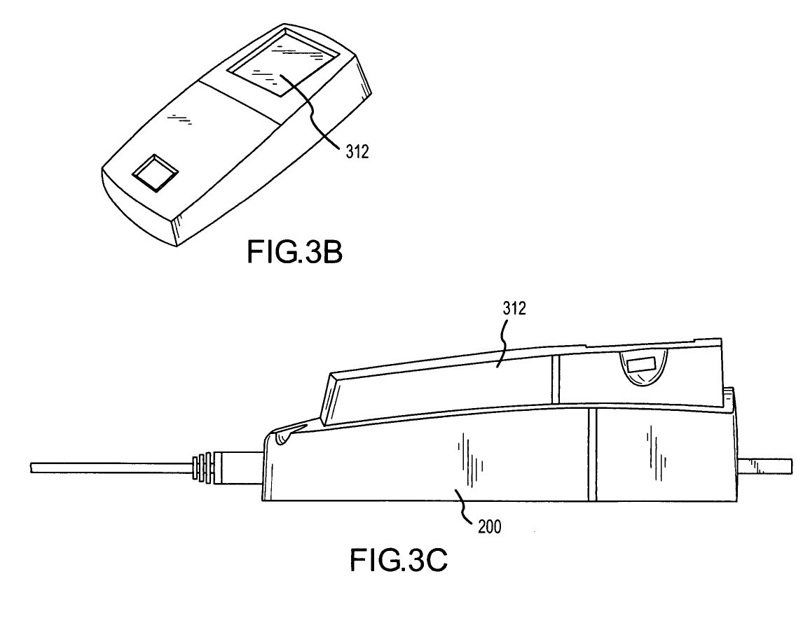

In operation, the imaging system 100 facilitates the generation, storage, and transfer of image data relating to a target. Referring to FIG. 4, in the present exemplary embodiment, the image system 100 is prepared for generating image data. For example, the sensor 110 is placed in line with a target and a radiation source, such as a conventional x-ray gun (410). In the present dental imaging system, the sensor 110 is suitably placed in the patient's mouth adjacent the target teeth, and the x-ray gun is placed on the opposite side of the target teeth and outside the patient's mouth.

The imaging system 100 may then be activated in any appropriate manner (412). For example, the imaging system may be activated using a remote system, such as a remote computer system connected to the data processing unit 112 via a network. In this context, the remote computer operates as a master unit and the data processing unit 112 as a slave unit. Alternatively, the imaging system 100 may be activated directly through the data processing unit 112, such as by depressing an appropriate button or key on the keyboard 258. When the system is activated, the timing and control system 214 suitably sends a control signal to the sensor 110. The timing and control system 214 may send an activation signal to the x-ray gun or can detect the x-ray exposure in any suitable manner. Radiation passing from the x-ray gun through the target is recorded by the sensor 110, which generates corresponding electrical signals.

The analog signals from the sensor 110 are provided to the conversion component 210. The conversion component 210 performs the preliminary processing and converts the analog sensor data into digital form for use by the remaining components of the data processing unit 112 (414).

The digital data is then transmitted to the image enhancement module 242 for image processing. The image processing may be no more than storage or transfer of the digital image, for example into the local memory or to another device. In the present embodiment, the image enhancement module 242 performs image enhancement processes, such as auto-balancing and noise removal (416). For auto-balancing, the image enhancement module 242 is suitably configured to adjust the brightness and/or contrast in the image. For example, the image enhancement module 242 may be configured to extract information from the image data and perform adaptive image processing to adjust the image.

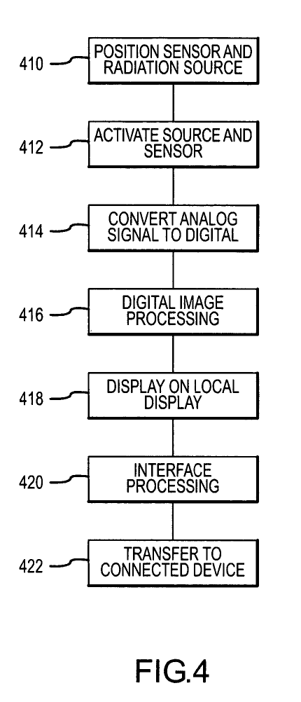

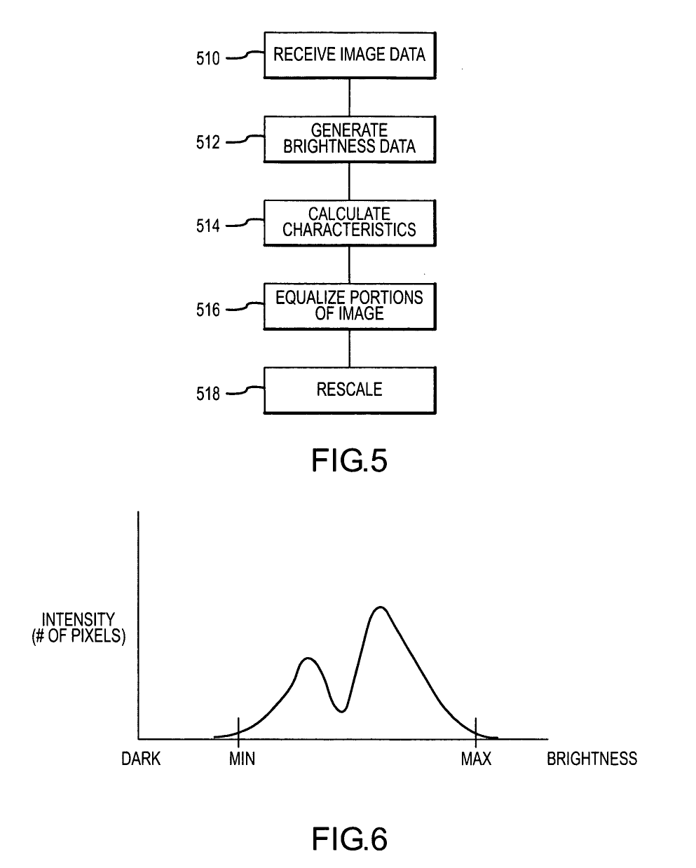

In particular, referring to FIG. 5, the image enhancement module 242 receives the digitized image data from the sensor 110 or the memory 260 (510). The image enhancement module 242 then extracts characteristics from the image data, for example by constructing a brightness histogram for the image (512) (FIG. 6). The histogram tends to highlight brightness levels in the image data, such as pixels that correspond to desired data and pixels that may be subject to noise or other undesired data. The histogram and/or other data may facilitate adjustment of the brightness or contrast of the overall image.

For example, in the present embodiment, the image enhancement module 242 constructs the histogram of the image data and balances the brightness of the image data based on the histogram. The image enhancement module 242 suitably establishes one or more brightness thresholds, such as a minimum brightness threshold and a maximum brightness threshold, for filtering data. Pixels associated with image data below the minimum brightness threshold and above the maximum brightness threshold are suitably assigned uniform values, such as the lowest and highest brightness levels available, respectively. The remaining values between the minimum and maximum thresholds are suitably adjusted to balance the values over the output scale of available brightness values.

To illustrate operation of an exemplary image enhancement module 242, a particular image may comprise 50 million pixels. The image enhancement module 242 suitably processes the image data to generate a brightness histogram. Using the histogram, the image enhancement module 242 generates a minimum brightness threshold and a maximum threshold based on preselected thresholds, such as a four percent minimum threshold and a one percent maximum threshold. Thus, the image enhancement module 242 identifies the two million darkest pixels and the 500,000 brightest pixels in the image data. The image enhancement module 242 may then adjust the pixels having brightness values below the minimum brightness threshold fully black and those above the maximum brightness threshold fully bright (516).

In addition, the image enhancement module 242 also suitably calculates a gain factor for balancing the remaining data across the available brightness scale. The gain factor may be calculated according to any appropriate criteria or algorithm, such as by dividing the difference between the maximum brightness threshold and the minimum brightness threshold in the image by the magnitude of the output scale, i.e., the range of possible brightness values. Thus, for an 8-bit system, the output scale is 256, so the gain factor may be expressed as:

Gain=(max brightness threshold−min brightness threshold)/256

Using these calculations, the remaining data between the minimum brightness threshold and the maximum brightness threshold may be adjusted to increase or decrease the overall brightness or contrast of the image and/or otherwise adjust the image data. For example, the image data for each pixel may be adjusted according to the following equation:

P_{adj}=Output Scale−(max−P_{raw})/gain

where P_{adj} is the adjusted pixel brightness, Output Scale is the output scale, max is the maximum brightness threshold, P_{raw} is the original pixel brightness, and gain is the gain factor. Finally, the quantization of the image data may be changed, for example from a 16-bit to an 8-bit (518). Any appropriate process may be used, however, for example using a gain algorithm or a compression algorithm.

The image enhancement module 242 may also be configured to perform noise removal from the image data. For example, as described in conjunction with FIG. 7, the image enhancement module 242 may calculate the noise dispersion and select noise filters accordingly. The image enhancement module 242 may also be configured to implement additional or alternative noise reduction processes.

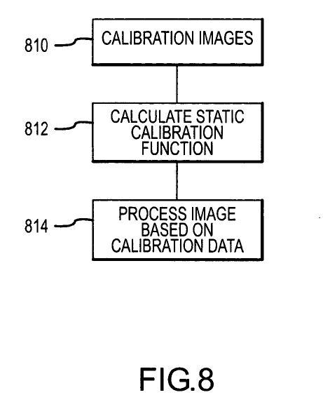

For example, referring to FIG. 8, the image enhancement module 242 may be configured to process image data in conjunction with a static calibration function, such as a long exposure or “stuck pixel” noise reduction process. In the present embodiment, the sensor 110 is isolated from x-ray radiation and data from the sensor 110 is read one or more times by the data processing unit 112 to generate calibration data (810). Because the sensor is not exposed to x-rays or other relevant radiation, the only data from the sensor 110 is unwanted data, such as thermal noise and distortions from the sensor and the data processing unit 112. Any suitable process for measuring noise and generating calibration data, however, may be used.

The calibration data received from the sensor 110 is then suitably used to generate a static calibration function (812). For example, the image enhancement module 242 may be configured to implement a static calibration function in which averaged calibration data, such as averaged calibration data relating to thermal noise as described above, is subtracted from the image data. When the image data is received, the image enhancement module 242 may then process the data in accordance with the static calibration function to reduce noise (814).

Referring again to FIG. 4, the image data may be displayed, for example on a separate display, like a monitor or a computer display, or a dedicated display, such as the integrated display 256 (418). In the present embodiment, the processed image data is provided to the display controller 254 to facilitate display of the image on the display 256. By displaying the data on the dedicated display, the operator can confirm the acceptability of the images before transferring the image data to a connected device. In addition, the processing of the image prior to display or transfer of the data to a connected device tends to assure that the image is acceptable or allow the image to be retaken relatively quickly.

For transfer of the data to another device, the image data may be processed by the interface processing module 244 to convert the data to a desired format (420). The transfer and the selection of format may be performed in any suitable manner. For example, the user may select a destination device, such as a printer or storage system, from the data processing unit 112 by using the keyboard 258. By selecting the destination device, the interface processing module 244 may automatically format the data for the destination device.

Alternatively, another device may request the transfer of data from the data processing unit 112, for example by submitting a request from a personal computer via a network. The request may specify one or more destination devices, such as a hospital storage system, and the interface processing module 244 may automatically format the image data for the selected destination devices. The formatted image data may then be transferred to the destination devices (422).

The particular implementations shown and described are illustrative of the invention and its best mode and are not intended to otherwise limit the scope of the present invention in any way. Indeed, for the sake of brevity, conventional manufacturing, processing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. A dental image data processing unit configured to receive a set of image data and provide the image data to at least one external device in a plurality of external devices, comprising an interface processing module configured to receive the image data and convert the image data into a format compatible with the at least one external device.

2. A dental image data processing unit according to claim 1, wherein the dental image data processing unit is configured to be connected to the external device via a wireless connection.

3. A dental image data processing unit according to claim 1, wherein the format is a DICOM format.

4. A dental image data processing unit according to claim 1, further comprising a network interface configured to connect the dental image data processing unit to a network.

5. A dental image data processing unit according to claim 1, further comprising an image enhancement module, wherein the image enhancement module is configured to receive the image data, enhance the image data, and provide the enhanced image data to the interface processing module.

6. A dental image data processing unit according to claim 5, wherein the image enhancement module is configured to at least one of reduce noise in the image data and remove artifacts from the image data.

7. A dental image data processing unit according to claim 5, wherein the image enhancement module is configured to adjust a plurality of brightnesses for a plurality of pixels across an output scale.

8. A dental image data processing unit according to claim 5, wherein the image enhancement module is configured to measure an amount of noise in the image data and select a filter according to the measured noise.

9. A dental image data processing unit according to claim 1, further comprising a sensor interface for receiving the image data from a sensor, wherein the sensor interface is compatible with multiple types of sensors.

10. A dental image data processing unit according to claim 1, further comprising a memory configured to receive image data and store image data.

11. A dental image data processing unit according to claim 1, further comprising a dedicated display configured to display an image corresponding to the image data.

12. A dental image data processing unit according to claim 11, wherein the dedicated display receives the image data via a wireless connection.

13. A dental image data processing unit according to claim 1, further comprising an external interface configured to receive the image data from the interface processing module and transmit the image data to the at least one external device.

14. A dental image data processing unit according to claim 13, wherein the external interface comprises a PC card interface and an Ethernet interface.

15. A dental image data processing unit according to claim 13, wherein the external interface comprises a wireless communication interface.

16. A data processing unit for a dental imaging system, comprising:
a sensor interface configured to connect to a dental sensor;
an image processing component connected to the sensor interface and configured to receive a set of image data via the sensor interface and to process the set of image data to generate a set of processed image data; and
an interface processing module configured to receive the processed image data from the image processing component and to provide data in multiple formats.

17. A data processing unit according to claim 16, wherein the interface processing module is configured to be connected to an external device via a wireless connection.

18. A data processing unit according to claim 16, wherein the multiple formats include a DICOM format.

19. A data processing unit according to claim 16, further comprising a network interface configured to connect the data processing unit to a network.

20. A data processing unit according to claim 16, wherein the image processing component is configured to at least one of reduce noise in the image data and remove artifacts from the image data.

21. A data processing unit according to claim 16, wherein the image processing component is configured to adjust a plurality of brightnesses for a plurality of pixels across an output scale.

22. A data processing unit according to claim 16, wherein the image processing component is configured to measure an amount of noise in the image data and select a filter according to the measured noise.

23. A data processing unit according to claim 16, wherein the sensor interface is compatible with multiple types of sensors.

24. A data processing unit according to claim 16, further comprising a memory connected to the configured to receive image data and store image data.

25. A data processing unit according to claim 16, further comprising a dedicated display configured to display an image corresponding to the image data.

26. A data processing unit according to claim 25, wherein the dedicated display receives the image data via a wireless connection.

27. A data processing unit according to claim 16, further comprising an external interface configured to receive the image data from the interface processing module and transmit the image data to at least one external device.

28. A data processing unit according to claim 27, wherein the external interface comprises a PC card interface and an Ethernet interface.

29. A data processing unit according to claim 27, wherein the external interface comprises a wireless communication interface.

30. An imaging system for providing data to multiple external devices, comprising:
a dental sensor; and
a data processing unit, wherein the data processing unit is configured to:
receive data from the sensor; and
provide the data to the multiple external devices in multiple formats compatible with the multiple external devices.

31. An imaging system according to claim 30, wherein the data processing unit is configured to be connected to the multiple external devices via a wireless connection.

32. An imaging system according to claim 30, wherein at least one of the multiple formats is a DICOM format.

33. An imaging system according to claim 30, further comprising a network interface configured to connect the data processing unit to a network.

34. An imaging system according to claim 30, wherein the data processing unit further comprises an image enhancement module configured to enhance the data.

35. An imaging system according to claim 34, wherein the image enhancement module is configured to at least one of reduce noise in the data and remove artifacts from the data.

36. An imaging system according to claim 34, wherein the image enhancement module is configured to adjust a plurality of brightnesses for a plurality of pixels across an output scale.

37. An imaging system according to claim 34, wherein the image enhancement module is configured to measure an amount of noise in the data and select a filter according to the measured noise.

38. An imaging system according to claim 30, further comprising a sensor interface for receiving the data from the dental sensor, wherein the sensor interface is compatible with multiple types of dental sensors.

39. An imaging system according to claim 30, wherein the data processing unit further comprises a memory configured to receive data and store data.

40. An imaging system according to claim 30, further comprising a dedicated display connected to the data processing unit and configured to display an image corresponding to the data.

41. An imaging system according to claim 40, wherein the dedicated display receives the data via a wireless connection.

42. An imaging system according to claim 30, wherein the data processing unit further comprises an external interface configured to receive the data and transmit the data to the multiple external devices.

43. An imaging system according to claim 42, wherein the external interface comprises a PC card interface and an Ethernet interface.

44. An imaging system according to claim 42, wherein the external interface comprises a wireless communication interface.

45. A method of acquiring dental image data relating to a target, comprising:
generating a set of image data corresponding to the image of the target;
converting the image data into a format compatible with a selected external device in a set of accessible external devices; and
providing the image data in the compatible format to the selected external device.

46. A method of acquiring dental image data according to claim 45, further comprising enhancing the image data to generate a set of enhanced image data.

47. A method of acquiring dental image data according to claim 46, wherein enhancing the image data comprises at least one of reducing noise in the image data and removing artifacts from the image data.

48. A method of acquiring dental image data according to claim 46, wherein enhancing the image data comprises adjusting a plurality of brightnesses for a plurality of pixels across an output scale.

49. A method of acquiring dental image data according to claim 46, wherein enhancing the image data comprises:
measuring an amount of noise in the image data; and
selecting a filter level according to the measured amount of noise.

50. A method of acquiring dental image data according to claim 45, further comprising storing the image data in a local memory.

51. A method of acquiring dental image data according to claim 45, further comprising displaying an image corresponding to the image data on a dedicated display.

52. A method of acquiring dental image data according to claim 51, wherein displaying the image includes transmitting the image data to the dedicated display via a wireless connection.

53. A method of acquiring dental image data according to claim 51, wherein displaying the image includes transmitting the image data to the dedicated display via a wireless connection.

54. A method of acquiring dental image data according to claim 45, wherein providing the image data includes providing the image data to the selected external device via a wireless connection.

55. A method of acquiring dental image data according to claim 45, wherein the compatible format is a DICOM format.

56. A method of acquiring dental image data according to claim 45, wherein:
converting the image data comprises converting the image data into a network format; and
providing the image data includes providing the image data to the selected external device via a network.
